(19) United States
(12) Patent Application Publication
(10) Pub. No.: US 2024/0064045 A1
(43) Pub. Date: Feb. 22, 2024

(54) METHODS AND DEVICES FOR FREEZING OR ADAPTING PARAMETERS OF A NEURAL NETWORK WHICH ARE USED IN A TELECOMMUNICATION NETWORK

(71) Applicant: Orange, Issy-les-Moulineaux (FR)

(72) Inventors: Louis Adrien Dufrene, Châtillon Cedex (FR); Quentin Lampin, Châtillon Cedex (FR); Guillaume Larue, Châtillon Cedex (FR)

(21) Appl. No.: 18/259,751

(22) PCT Filed: Dec. 23, 2021
(86) PCT No.: PCT/FR2021/052448

§ 371 Date: Jun. 28, 2023

(30) Foreign Application Priority Data
Dec. 30, 2020 (FR) 2014244

(51) Int. Cl. H04L 25/02

(52) U.S. Cl. CPC H04L 25/0254

(57) ABSTRACT

In a communication network, an item of equipment uses a first neural network to implement a signal processing function in order to process an input signal received over a communication channel to obtain an output signal. A system for adapting the parameters of the first network, after a change in the channel, sends information items about the change for processing by a second neural network trained in association with the first neural network and used to determine parameters of the first network that are to be frozen and parameters of the first network that are to be adapted following a change in the channel. The system also obtains information items supplied by the second neural network which identify the determined parameters of the first network to be frozen and adapted following the detected change, and adapts the identified parameters of the first neural network using the supplied information items.

### PRIOR ART

The invention relates to the general field of telecommunications. More specifically, the invention relates to the field of signal processing using neural networks in telecommunications networks.

FIG. 1 represents a communication network of the state of the art, for example a cellular communication network, in which a neural network NR can be implemented. The network includes at least a mobile terminal equipment UE, connected via a radio communication channel CN to a base station type equipment BS. Assuming that the terminal UE emits a radio signal x(t) to the base station BS, the base station BS will receive a radio signal y(t) different from the emitted signal x(t). Indeed, the emitted signal x(t) undergoes alterations due to its propagation on the radio channel CN.

To mitigate the effects of the channel CN, the base station implements a network function in the form of a neural network NR to estimate, from the received signal y(t), the signal x(t) emitted by the terminal UE. To this end, the radio channel CN is modeled by choosing the functions of the different neurons, and by training the neural network NR so that it determines the parameters (weight P and bias) of each neuron during a phase of learning of the network NR. For example, during this phase, the neural network NR receives a plurality of signals y′(t) corresponding respectively to emitted signals x′(t) belonging to a set of known sequences. Once the learning phase is complete, the neural network is capable of estimating an emitted signal x(t) for a new received signal y(t).

A problem arises if the radio channel CN evolves over time, for example due to the displacement of the terminal UE, to the climatic conditions, to the appearance or disappearance of obstacles to the transmission of signals on the channel CN, to the evolution of a number of terminals connected to the base station BS, to the evolution of interference of other channels with the channel CN, etc. When the radio channel CN evolves, it is necessary to adapt (relearn) the neural network NR to take into account the evolution of the channel CN and improve the estimation of the signal x(t).

The adaptation of the neural network requires time and resources in terms of memory and computing capacity. The adaptation is all the more time-consuming and costly as the neural network model is complex. However, in this context of use of the neural network in a communication network, the adaptation of the neural network must be fast on the coherence time scale of the communication channel. In addition, the data used for the learning and the adaptation, for example pilot sequences, consume resources otherwise used to communicate. They should therefore be used sparingly, and the adaptation must be possible on small amounts of data.

A solution may consist in using a neural network with a less complex architecture, so that its adaptation is faster, easier and less expensive, but such a network presents a less good expressiveness. A complexity of a neural network is for example defined in terms of number of parameters, number of neurons, number of layers. It is recalled that the expressiveness of the neural network NR represents its ability to approximate the implemented signal processing function, for example the equalization function. The latter makes it possible to correct the received signal to facilitate its demodulation. This modification is made according to the channel CN. A less good expressiveness therefore affects the reliability of the estimation of the emitted signal x(t).

Another solution may consist in taking into account, during the adaptation, only some parameters, for example the weights and/or the biases of a limited number of neurons, by suspending (freezing) the weights and/or the biases associated with other neurons. This technique is called weight freeze. This solution is not satisfactory because it requires knowing the weights and the biases to be suspended. An arbitrary automatic choice of these weights or biases does not guarantee that the equalization applied to the received signal y(t) to estimate the zmitted signal x(t) is reliable.

The intervention of a skilled person to configure hyper-parameters of the neural network, such as the weights and/or the biases to be suspended, represents an impractical and slow solution, in particular when the neural network is deep, that is to say having a high number of layers. Indeed, if the roles of the different layers of the neural network are not clearly defined (for example a specific layer to compensate for a rotation or a specific layer to compensate for an attenuation of the signal propagated on the channel), it is difficult or even impossible to identify the parameters that can be frozen.

Another solution called stochastic depth which consists of varying the depth of the neural network randomly during the adaptation phase is also known. Each layer of the network can be ignored with a certain probability. This solution has the same drawbacks as those of the “weight freeze” solution. In addition, the stochastic aspect does not guarantee a relevant adaptation of the neural network according to the evolution of the channel.

There is therefore a need for a solution which allows rapid and reliable adaptation of the parameters of a neural network used in a communication network, and which does not have the drawbacks of the methods of the state of the art.

### DISCLOSURE OF THE INVENTION

The invention relates to a method for adapting the parameters of a first neural network used in a communication network to implement a signal processing function by an equipment, to process an input signal received by the equipment on a communication channel in order to obtain an output signal, the method including steps of:
following a detection of a degradation in the quality of said processing function due to an evolution of said channel, sending information on this evolution for a processing by a second neural network, the second neural network being used to determine parameters of the first network to be frozen and parameters of the first network to be adapted following an evolution of the channel;
obtaining information, provided by the second neural network, that identifies parameters of the first network to be frozen and parameters of the first network to be adapted following the detected evolution; and
adapting the identified parameters of the first neural network by using the information provided by the second neural network.

Correlatively, the invention relates to a first device configured to adapt, according to the proposed adaptation method, parameters of a first neural network.

The characteristics and advantages of the proposed adaptation method presented below apply in the same way to the first proposed device and vice versa.

A parameter of the neural network designates a weight and/or a bias of this network.

“Freezing” or “suspending” a parameter, designates the fact of not taking into account this parameter during the adaptation of the network. In other words, a frozen parameter is not adapted and is not changed following the evolution of the channel.

The first neural network can be of the DNN (Deep Neural Network) type, that is to say it includes a considerable number of layers of neurons to be able to model the communication channel with some reliability. The first neural network has noticeable expressiveness.

In one embodiment, the signal processing function corresponds to the equalization of the communication channel by an estimatation of the signal emitted by an emitter equipment on the channel to a receiver equipment (the first device in accordance with the invention) which implements the processing function. The input signal corresponds to the signal received by the receiver equipment and the output signal then corresponds to the estimation of the emitted signal. In this example, the first neural network models the equalization function of the communication channel. This includes compensating for the complex non-linearity effects of the power amplifiers or the effects related to its propagation on the channel, such as power decrease, a phase rotation, a masking and/or an offset.

The proposed technique makes it possible to reduce the time, the memory and the computational capacity required for the adaptation of the first neural network, while ensuring an optimized adaptation according to the evolution of the channel. Indeed, the first network does not need to adapt all its parameters, or to arbitrarily identify the parameters to be frozen or adapted, or to require an intervention from a skilled person. When the first neural network strictly obeys the second neural network, only the parameters identified “to be adapted” are adapted, the other parameters being frozen.

The parameters to be frozen and the parameters to be adapted are not chosen arbitrarily. On the contrary, these parameters are determined by the second neural network in order to optimize the adaptation of the first network according to the evolution of the channel.

Compared to the methods of the state of the art where the parameters to be frozen or adapted are determined by a skilled person, the proposed technique presents a faster and more reliable solution. Indeed, these parameters are determined by the second neural network, without any constraint on the definition of the roles fulfilled by the different layers of the first neural network, or on the distribution of the roles between the different layers, contrary to the method of the state of the art requiring a layer to be defined exclusively for a given role (such as a compensation for a power attenuation of the signal received on the channel, or a compensation for a phase of rotation of this signal) for the skilled person to be able to identify the layers, the weights and/or the biases to be frozen or adapted following the evolution of the channel.

In one embodiment, the detection of a degradation in the quality of said processing function due to an evolution of the channel includes a comparison between a threshold and a value of a variation of a characteristic of propagation of an input signal received on said channel.

In this embodiment, if the variation of the characteristic exceeds the threshold, the first device proposed detects that the channel has evolved. This can take place for example following a displacement of an equipment emitting the input signal, or a connection of other equipments to the first device proposed, or the presence of a new obstacle between the emitter equipment and the first device proposed.

The signal propagation characteristic can be an amplitude, a phase or a latency. Particularly, the first device proposed can be a terminal or a base station able to measure this characteristic.

Following the evolution of the communication channel, it may be necessary to adapt the parameters of the first neural network. Particularly, the first network proposed can consider that the quality of its processing function is degraded as soon as an evolution of the channel is detected. The first device proposed then sends the information on the evolution of the channel for a processing by the second neural network, which determines which parameters to be frozen and which parameters to be adapted.

In one particular embodiment, the channel is modeled as a set of paths represented by complex coefficients. This vector of coefficients is convolved with the input signal to give the output signal. The evolution of the propagation channel is measured by a difference in phase and/or amplitude of the complex coefficients of the channel.

In one particular embodiment, the detection of a degradation in the quality of said processing function due to an evolution of the channel includes a comparison, for a given input signal, between an output signal obtained by the processing function and a reference signal.

According to this embodiment, the reference signal corresponds to an output signal when the processing function is applied to the input signal and when the first network is optimized for the communication channel. If the difference between the output signal and the reference signal exceeds a certain threshold, the first proposed device observes degradation in the performance during the implementation of the processing function and then decides that an adaptation is required.

In one particular embodiment, the proposed adaptation method further comprises sending, in association with the information on the evolution of the channel, at least one parameter of the first neural network among a weight and a bias, a value of a loss function and/or at least one component of the gradient of the loss function.

This embodiment makes it possible to inform the second neural network of the current value of this characteristic (parameter, value of the loss function and/or component of the gradient), in particular when the two neural networks are implemented by two different devices. It is noted that the loss function is a function used by the first neural network to evaluate the quality of its processing function. The gradient of the loss function is evaluated to provide a direction towards which the parameters of the first network evolve in order to reduce the loss function and therefore to improve the quality of the processing function, in other words to improve the relevance of the estimation of a target signal x(t).

Particularly, when the second neural network uses an approach of back-propagation of the gradient in its learning phase, the first neural network sends it the component of the gradient and the value of the weight or of the bias likely to be adapted.

In one particular embodiment of the proposed adaptation method, the information on the evolution of the channel includes:
values of propagation characteristics on the channel before the evolution, for which the first neural network is optimized; and
estimated values of these characteristics following the evolution.

In one particular embodiment of the proposed adaptation method, the information on the evolution of the channel includes a complex difference between values of characteristics of propagation on the channel before the evolution and values of these characteristics after the evolution.

In one particular embodiment, the first neural network obeys the second neural network by strictly applying the information provided by the second network.

The invention also relates to a method for determining parameters of a first neural network to be frozen or adapted, the first neural network being used in a communication network to implement a signal processing function by an equipment, to process an input signal received on a communication channel in order to obtain an output signal, the method including steps of:
learning a second neural network in association with said first neural network;
obtaining information on an evolution of the channel resulting in a degradation in the quality of said processing function;
determining by the second neural network, from the information obtained, the parameters of the first network to be frozen and the parameters of the first network to be adapted following the evolution of the channel; and
providing to the first neural network information that identifies the parameters to be frozen and the parameters to be adapted.

Correlatively, the invention relates to a second device configured to determine, according to the proposed determination method, parameters of a first neural network to be frozen or adapted.

The characteristics and advantages of the proposed determination method presented below apply in the same way to the second proposed device and vice versa.

The characteristics and advantages of the adaptation method (and of the first device) proposed apply in the same way to the determination method (and to the second device) proposed and vice versa.

The second neural network is used in the communication network in association with at least a first neural network as described previously. The second neural network is used to determine parameters of the first network to be frozen and parameters of the first network to be adapted following an evolution of the channel and a degradation in the quality of the processing function. The interpretation of the information provided by the second neural network is known by the first neural network. The sending, receipt and/or interpretation of information by a neural network designates the sending, receipt and/or interpretation of this information by the device that implements this neural network, whether in a learning or inference phase.

The proposed technique presents a functional approach. The second neural network is trained to operate with the first neural network. Based on the evolution of the communication channel, the second network is able to determine in advance the parameters of the first network that need to be optimized. This anticipation is done for example by a predictive estimation of the value of the gradient of a loss function, assuming that the first network is optimized for the channel before the evolution or during the previous phase of learning of the first network. By analyzing the nature of the evolution of the channel (such as a rotation, an attenuation or the like) and by performing its function in association with the first network, the second network is able to find the parameters significantly impacted by this evolution of the channel and to differentiate them from those that do not need to be optimized (adapted) to respond to the evolution of the channel.

The second neural network determines a probability that a parameter of the first network should be frozen or adapted. The second neural network is based on the information relating to the evolution of the channel to determine the probabilities.

In one particular embodiment, the information provided to the first neural network includes the probabilities determined for parameters of the first network.

In another particular embodiment of the determination method, the information provided to the first neural network includes a table of binary data (bitmap) whose elements are obtained from the probabilities determined for parameters of the first network. For example, the elements of the list can be digits zero (0) for the parameters to be frozen associated with a probability strictly less than 0.5 (½), and digits one (1) for parameters to be adapted associated with a probability greater than or equal to 0.5 (½).

Each of the first and second neural networks can be trained completely or partially in online mode, that is to say in parallel with a phase of inference of this network, or in offline mode, that is to say before the inference phase. Each of these neural networks can be trained from real or simulated communication channels.

The first network is trained by input signals and output signals from a pilot sequence.

The second neural network according to the invention is trained in association with the first neural network. Before implementing a learning of the second neural network, the first neural network is already trained for an initial state of the communication channel. Following a first detection of an evolution of the channel, the first network is adapted according to a method of the state of the art. In a supervised learning of the second network, the first network sends to the second network information on the evolution of the channel, as well as the parameters of the first network before and after the evolution of the channel. The second network is trained based on the information on the evolution and the parameters of the first network.

It is possible that the learning (training) of the second neural network requires information on several evolutions of the channel and parameters of the first network before and after these evolutions, until the second neural network is optimized. In one embodiment, at least a first part of the phase of learning of the second network is performed in offline mode. Particularly, the entire phase of learning of the second network can be performed in offline mode. Metrics are used to determine whether the second network is optimized and whether its training is complete.

Following a subsequent detection of an evolution of the channel, the first network sends to the second network information on the evolution of the channel. The second network already trained is able to determine the parameters to be adapted of the first network and the parameters to be frozen of the first network for a rapid optimization of the first network according to the evolution of the channel.

As part of a reinforcement learning of the second neural network:
the first neural network sends to the second network characteristics of the channel before and after an evolution of the channel, the first network being already trained for the characteristics of the channel before the evolution;
the second neural network randomly determines parameters of the first network to be adapted and parameters of the first network to be frozen, and provides to the first network information identifying these parameters;
the first network adapts its parameters by applying the information it has received, executes its processing function during an inference phase, and then sends to the second network information relating to the quality of the processing function after this adaptation. Pilot sequences (comprising input signals for the first network and output signals corresponding to these input signals) are used for this learning of the second network;
the second network evaluates the influence of the adapted parameters and of the frozen parameters on the processing function, possibly adjusts the identification of the parameters to be adapted and of the parameters to be frozen, and sends new information identifying these parameters to the first network. Similar exchanges between the first and the second neural network, following new evolutions of the channel, are repeated until the second neural network is optimized.

In one particular embodiment, during the learning step of the second neural network, this second network is trained by:
values of the characteristics of the channel before and after an evolution; and
parameters of the first neural network already trained and/or output signals of the processing function associated with said values of the characteristics of the channel.

This learning allows the second network to establish a match between the parameters of the first network and the variation of the values of the characteristics of the channel. At the end of this learning phase, the second network is able to predict the parameters (weight and/or bias) that are significant for the adaptation and optimization of the first neural network. The insignificant parameters are not or little modified during a future phase of learning of the first network and their modification would not lead to a significant reduction in a loss function used for the back-propagation of the gradient at the level of the first network. These insignificant parameters are indicated by the second network as having to be frozen. Particularly, a weight or a bias can be frozen during gradient backpropagation.

Particularly, the output signals used for the learning of the second neural network may have been used for the learning of the first network.

In one particular embodiment of the determination method, the information identifying the parameters to be frozen and the parameters to be adapted include at least one rate of learning of a parameter of the first neural network and/or at least one weight value associated with a learning rate.

In the first case, the second network directly provides at least one learning rate to the first network. It is recalled that according to the state of the art, a learning rate is a multiplicative parameter which can weight the value of a gradient during a back-propagation of the gradient. In the second case, the second network provides to the first network at least one weight value of a learning rate, which itself (the learning rate) can weight the value of the gradient. In the second case, the first network deduces and can apply for a given parameter, a learning rate obtained from a certain reference learning rate and the weight value provided by the second network. The reference learning rate can be obtained during a configuration of the first neural network. Particularly, this reference learning rate can be specific for a given parameter of the first network. Alternatively, it is identical for all the parameters of the first network.

This embodiment makes it possible to specify to the first network the rate according to which a parameter must be adapted, this rate possibly being less than 100%. The quality of the processing function is considered acceptable when the parameters of the first network are adapted according to the learning rates provided by the second network or deduced from the weight values. In addition, this embodiment further makes it possible to save the resources necessary for the adaptation of the parameters of the first network, in terms of computing capacity, because the parameters to be adapted are not all necessarily adapted with a learning rate of 100%. In addition, being based on an optimized learning rate can reduce the number of back-propagation steps and accelerate the adaptation of the parameters concerned.

This embodiment therefore allows an even faster adaptation of the parameters of the first network, without affecting the expressiveness of the first network.

In one particular embodiment, the adaptation method comprises, before said adaptation, a modification of the information provided by the second neural network and used for the adaptation of the parameters of the first network.

For example, if the information provided by the second network includes rates of learning of some parameters to be adapted, the first network can be configured to modify these rates before the adaptation, for example by considering rates lower than the rates provided by the second network in order to further reduce the time and/or the computing capacity necessary for the adaptation.

In one particular embodiment of the determination method, the information identifying the parameters to be frozen and the parameters to be adapted include real scalar numbers, for example comprised between 0 and 1, and which represent learning rates or learning rate weight values.

In one particular embodiment, the determination method further comprises providing to the first neural network initial values to initialize parameters of the first network to be adapted.

It is noted that the initial values of the parameters of the first network have an impact on the quality of the processing function. Optimized initial values allow reducing the number of steps of a back-propagation.

The second neural network can determine the initial values in the same way that it determines the parameters to be frozen or adapted. Particularly, the second neural network can be further trained by the initial values of the parameters of the first network already optimized for some values of characteristics of the communication channel.

The invention also relates to a system for adapting the parameters of a first neural network, this system including at least a first device in accordance with the invention and a second device in accordance with the invention.

In one embodiment, the second device that determines the parameters to be frozen or adapted has more resources in terms of memory and computing capacity than the first device that performs the adaptation of the parameters of the first neural network.

In another embodiment, the adaptation of the parameters of the first neural network, and/or the adaptation of the parameters of the second neural network can be performed by the same device.

As proposed, the execution of a said neural network (in a phase of inference of the neural network) can be performed by a device other than the one that performs the learning and/or the adaptation of the parameters of this neural network. The device performing the learning or the adaptation sends the parameters of the neural network to the device executing it.

In one embodiment of the invention, the first device is a base station, for example of the eNodeB, advanced eNodeB or gNodeB type, and the second device is a server of the core of the communication network, for example a datacenter type server. The second device can perform centralized calculations for several first devices of the base station type. The communication network can be a cellular network, for example of the 3G, 4G, 5G type (of the third, fourth, fifth generation) or a later generation.

In one embodiment of the invention, the first device is a terminal such as a mobile telephone, a computer, a connected car, a connected watch, a tablet or any other user equipment. The second device is a server of the core of the communication network, for example a datacenter type server. The first and second devices communicate with each other via a base station, for example of the eNodeB, advanced eNodeB or gNodeB type.

The invention has an advantageous application when the processing function is applied to signals exchanged in a physical layer of a sixth-generation 6G communication network.

The adaptation of the parameters of the first network according to the proposed technique can be practically in real time, as the evolution of the channel is being detected.

The invention has an advantageous application in the context of the standardization of the modes of exchange between the equipments of a communication network for the implementation of the neural networks.

The invention also relates to a computer program on a recording medium, this program being capable of being implemented in a computer or in the first device proposed. This program includes instructions adapted to the implementation of an adaptation method as described above, when the program is executed by a computer.

The invention also relates to a computer program on a recording medium, this program being capable of being implemented in a computer or in the second device proposed. This program includes instructions adapted to the implementation of a determination method as described above, when the program is executed by a computer.

Each of these programs may use any programming language, and be in the form of source code, object code, or intermediate code between source code and object code, such as in partially compiled form, or in any other desirable form.

The invention also relates an information medium or a recording medium readable by a computer, and including instructions of a computer program as mentioned above.

The information or recording medium may be any entity or device capable of storing the program. For example, the medium may include a storage means, such as a ROM, for example a CD ROM or a microelectronic circuit ROM, or a magnetic recording means, for example a hard disk, or a flash memory.

On the other hand, the information or recording medium may be a transmissible medium such as an electrical or optical signal, which may be routed via an electrical or optical cable, by radio link, by wireless optical link or by other means.

The programs according to the invention can be particularly downloaded from an Internet-type network.

Alternatively, the information or recording medium may be an integrated circuit in which one of the programs is incorporated, the circuit being adapted to execute or to be used in the execution of a method in accordance with the ′invention.

### BRIEF DESCRIPTION OF THE DRAWINGS

Other characteristics and advantages of the present invention will become apparent from the description given below, with reference to the appended drawings which illustrate an exemplary embodiment without any limitation. On the figures:

FIG. 1, already described, illustrates an architecture of a communication network in which a neural network is used according to a method of the state of the art;

FIG. 2 is an architecture of a communication network in which proposed methods are implemented according to one particular embodiment;

FIG. 3 is a flowchart representing steps of an adaptation method and steps of a determination method implemented according to a first particular embodiment;

FIG. 4 is a flowchart representing steps of an adaptation method and steps of a determination method implemented according to a second particular embodiment;

FIG. 5 represents a functional architecture, according to one particular embodiment, of a system for adapting the parameters of a neural network; and

FIG. 6 represents a hardware architecture of a device for adapting the parameters or a device for determining the parameters to be frozen or adapted according to one particular embodiment.

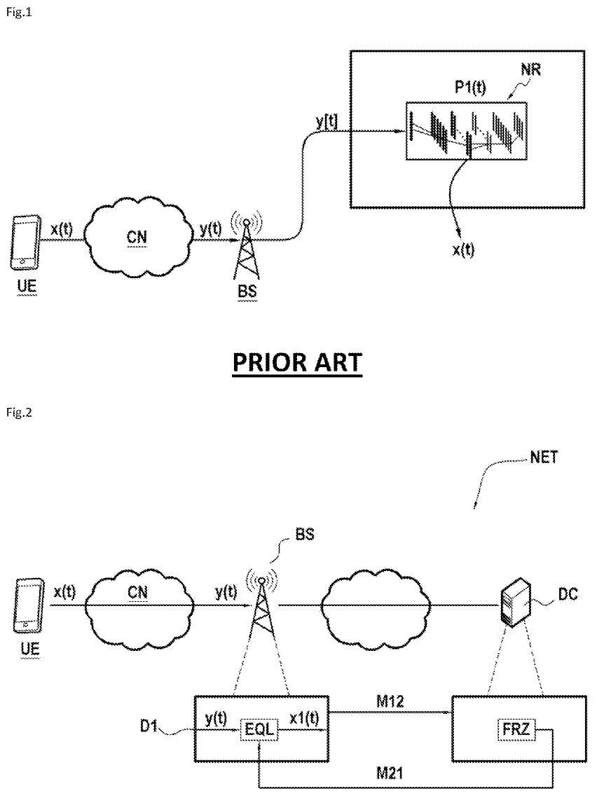

### DESCRIPTION OF THE EMBODIMENTS

FIG. 2 is an architecture of a communication network NET in which a method for adapting the parameters of a neural network and a method for determining the parameters to be frozen or adapted are implemented according to one particular embodiment.

In the method described here, the network NET is a cellular communication network, for example of the 3G, 4G, 5G type or later generation type. However, the proposed method can be implemented in communication networks based on other technologies. For example, the communication network NET can be an optical network.

The communication network NET includes at least one terminal UE of a user such as a mobile telephone, a tablet or a computer and at least one base station BS of the eNodeB or gNodeB type. A radio communication channel CN connects the terminal UE to the base station BS. The network NET also includes a datacenter DC type server. The base station BS and the server DC form an adaptation system SYS in accordance with the invention.

A radio signal x(t) emitted by the terminal UE to the base station BS undergoes alterations of the channel CN, for example complex non-linearity effects of the power amplifiers or the effects related to its propagation on the channel, such as an increase of its amplitude (its power), a masking, a rotation of a phase of the symbols comprised in the signal, a frequency offset, a sampling desynchronization, an interference with other signals transmitted on neighboring channels, etc. The base station receives a signal y(t) different from the emitted signal x(t).

The base station BS comprises a first device D1 in accordance with the invention. This first device D1 has the architecture of a computer. It is configured to implement a neural network EQL. The first device D1 is configured to perform the phase of learning of the network EQL, to adapt parameters P1(t) of this network EQL and also to execute it (inference phase) once the learning (or adaptation) phase is completed. This neural network EQL makes it possible to execute a signal processing function, such as an equalization function to mitigate the effects of the channel CN. The neural network EQL can be a DNN-type deep network, having a high complexity but also a qualitative expressiveness.

The neural network EQL is intended to estimate the signal x(t) emitted by the terminal UE from the signal y(t) received by the base station BS (also called input signal). The network EQL performs signal processing operations to implement the equalization function. The network EQL uses a certain error function. The result of the estimation of the signal x(t) by application of the network EQL is noted x1(t).

The first neural network EQL is configured to implement an equalization function. In general, this network EQL is configured to implement a signal processing function to process an input signal (y(t)) in order to obtain an output signal (x(t)). For example, the signal processing function may include time and/or frequency synchronization between the emitter and the receiver. To maintain this synchronization, it is necessary to perform a certain number of time/frequency drift measurements.

The server DC has the architecture of a computer and forms a second device in accordance with the invention. It is configured to implement a second neural network FRZ. The server DC is configured to perform the learning, the adaptation (relearning) and the execution of this neural network FRZ.

The parameters of the networks EQL and FRZ are noted respectively P1(t) and P2(t), these parameters comprising the functions, the weights and the biases of the neurons of each of these networks.

The second neural network FRZ is trained in association with the first neural network EQL. The second network FRZ is configured to determine parameters P1(t) of the first network EQL to be frozen and parameters P1(t) of the first network EQL to be adapted following an evolution of the communication channel CN.

The first network EQL is configured to send to the second network FRZ information M12 on an evolution of the channel CN, requiring an adaptation of the parameters P1(t). The second network FRZ provides to the first network EQL information M21 on the parameters P1(t) to be frozen and the parameters P1(t) to be adapted.

The first device D1 and the server DC are described as devices. Their network function can also be implemented by virtual functions (VNF for Virtual Network Function) running on equipments.

In one embodiment, the first device D1 is not part of the base station BS. It can be distant from the latter but receives the input signal y(t) therefrom.

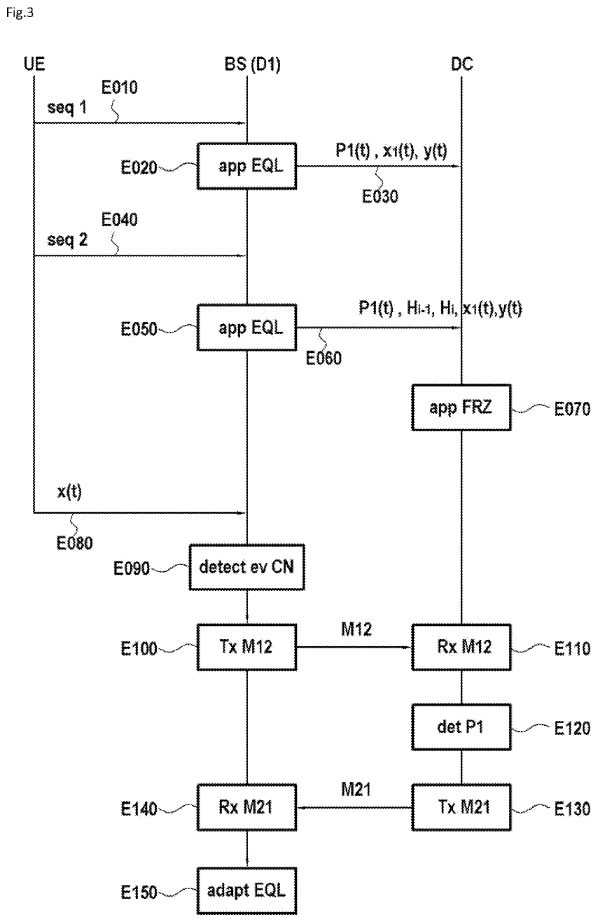

FIG. 3 is a flowchart representing steps of an adaptation method and steps of a determination method, implemented according to a first particular embodiment, respectively by the first device D1 and the server DC described with reference to FIG. 2.

During a step E010, the terminal UE, as an emitter, transmits a pilot learning sequence seq1 including symbols allowing the base station BS as a receiver, and particularly its first device D1, to estimate the communication channel CN. This learning sequence seq1 can be entirely or partially known by the first device D1, as well as its statistical properties. The emitted sequence seq1 includes all the target signals x(t) for the receiver device D1. By way of illustration, a sequence of deterministic symbols is of the Zadoff-Chu type. An example of such a sequence is defined in the 3GPP specification TS 38.211 “NR; Physical channels and modulation (Release 15)” v15.8.0.

During a step E020, the first device D1 of the base station BS learns the parameters P1(t) of the first neural network EQL. The terminal UE sends target signals x(t), corresponding to the learning sequence seq1, and the base station BS receives signals y(t), called input signals, which correspond to the signals x(t) following their alteration through the channel CN. The first device D1 trains its network EQL by using the input signals y(t) and the learning sequence seq1. For example, this learning (E020) iteratively updates the parameters P1(t) of the first network EQL by back-propagation of the gradient by minimizing a cost function (also called error function) based on the quality of the reconstruction of the known sequence seq1, performed by the network EQL.

At the end of the learning phase E020, and during a step E030, the base station BS sends to the server DC the parameters P1(t) for a supervised learning of the second neural network FRZ.

The learning E020 of the first network can be made online that is to say based on real signals y(t), or offline that is to say based on computer-simulated signals y(t).

It is assumed that the channel CN evolves and that the quality of the processing function implemented by the first neural network EQL degrades following this evolution.

During a step E040 and after the evolution of the channel CN, the terminal UE sends to the base station a pilot learning sequence seq2, which can be particularly similar to the pilot sequence seq1.

The first device then adapts the network EQL during a step E050. For example, this adaptation E050 can consist in iteratively updating the parameters P1(t) of the network EQL by back-propagation of the gradient by minimizing the cost function based on the quality of the reconstruction, by the model, of the known sequence seq2.

At the end of the adaptation phase E050, and during a step E060, the base station BS sends to the server DC:
the new parameters P1(t) determined following the evolution of the channel CN; and
values of characteristics of propagation of signals on the channel CN, before and after the evolution, for example the amplitude or the phase of a signal. These values of the characteristics, before and just after the evolution, are noted H(i-1) and Hi respectively.

During a step E070, the server DC learns the parameters P2(t) of the neural network FRZ. The learning of the parameters P2(t) is based on an observation of the parameters P1(t) which have been modified following the evolution of the channel CN and the amplitudes with which these parameters P1(t) have been modified. Depending on the amplitudes of the modifications observed, the second network FRZ can establish a threshold value below which it considers that a parameter P1(t) has not been significantly modified. The threshold value can be global for all the parameters P1(t) or specific for each parameter P1(t) of the network EQL.

It is assumed that during a step E080, the terminal UE sends a new signal x(t) on the channel CN to the base station BS. It is assumed that at least some of the characteristics of propagation on the channel CN have changed since the last adaptation (E050) of the first network EQL.

During a step E090 of the adaptation method according to the invention, the first device D1 of the base station BS detects a new evolution of the channel CN which results in a degradation of the processing function.

According to a first variant of the embodiment described here, the communication channel CN is modeled in the form of a set of paths represented by complex coefficients. This vector of coefficients is convolved with the transmitted signal x(t) to give the signal y(t). The evolution of the channel CN is measured by a difference in phase and/or amplitude of the complex coefficients of the channel. If the difference is greater than a given threshold, the first device D1 detects (E090) the evolution of the channel CN and decides that an optimization (relearning) of the network EQL is necessary.

According to a second variant, the first device D1 detects (E090) the evolution of the channel CN by observing a degradation in the performance of the processing function based on the estimated channel. The degradation is observed following a comparison, for a given input signal y(t), between an output signal x1(t) obtained by the processing function and an expected reference signal x(t).

Following the detection E090 of the evolution of the channel CN, the first device D1 sends to the server DC, during a step E100 of the adaptation method, information M12 on said evolution for a processing by the second neural network FRZ.

The information M12 can comprise the values Hi of the characteristics of the channel CN for which the network EQL is already optimized, as well as values H(i+1) estimated for these same characteristics after the evolution of the channel. Alternatively, the information M12 may comprise a complex difference between the values Hi of characteristics of propagation on the channel CN before the evolution and the estimated values H(i+1) of these characteristics after the evolution.

Optionally, the information M12 may further include at least one current value of a parameter of the first network EQL, for example the value of a weight or of a bias, and/or a value of the loss function and/or at least one component of the gradient of the loss function. This makes it possible to inform the second network FRZ of the current values if it does not know them. Particularly, the value of the loss function can represent for the second network an indication on the number of parameters of the first network that must be adapted.

During a step E110 of the determination method according to the invention, the server DC receives the information M12 from the first device D1.

During a step E120, the server DC determines, by the second neural network FRZ, and from the received information M12, the parameters P1(t) of the first network EQL to be frozen and the parameters P1(t) to be adapted following the evolution of the channel CN. More specifically, the second network FRZ determines for a given parameter P1, a probability that this parameter must be frozen or adapted.

During a step E130, the server DC and particularly the second network FRZ, provides to the first neural network EQL information M21 identifying the parameters P1(t) to be frozen and the parameters P1(t) to be adapted.

According to one variant, the information M21 includes a list of zero (0) and of one (1), respectively associated with parameters P1 to be frozen (0) or adapted (1). For example, the second network FRZ associates the number 0 with the parameters (to be frozen) for which a probability strictly less than 0.5 has been determined during step E120, and the digit 1 with the parameters (to be adapted) for which a probability greater than or equal to 0.5 has been determined. The information M21 forms a bitmap-type binary list.

According to another variant, the information M21 includes real scalar numbers. For example, these numbers can be comprised between 0 and 1 and weight learning rates associated with each of the parameters P1(t). The learning rate can be defined individually for each of the parameters P1(t) or be identical for all the parameters P1(t) or at least part of them. It is recalled that according to the state of the art, a learning rate is a multiplicative parameter that can weight the value of the gradient during the back-propagation of the latter.

The scalar values may be the probabilities determined during step E120. Alternatively, the second network FRZ can be configured to compare the probabilities determined during step E120 with a threshold and modify these probabilities in the information M21 provided to the first network EQL. For example, probabilities below a certain threshold (e.g. 0.2) can be rounded to 0 (frozen weight), thus making it possible to modulate the reduction of the complexity of the learning of the network EQL.

According to another variant, the information M21 includes scalar values which are learning rates associated with parameters P1(t).

The second network FRZ can be configured to further provide initial values used to initiate parameters P1(t) of the first network EQL to be adapted. The information M21 includes these initial values.

During a step E140 of the adaptation method, the first device D1 receives the information M21 provided by the second neural network FRZ, identifying the parameters of the first network EQL to be frozen or adapted following the detected evolution (E090), and possibly receives learning rates or weight values associated with learning rates for the parameters to be adapted.

During a step E150 of the adaptation method, the first device D1 adapts the identified parameters P1(t) of the first neural network EQL by using the information M21 provided by the second neural network FRZ. Particularly, the first network takes into account initial values of the parameters P1 if these values are present in the information M21.

In the method described here with reference to FIG. 3, the first network EQL strictly obeys the second network FRZ, it adapts its parameters P1(t) in accordance with the information M21. In another embodiment, the first neural network EQL modifies the received information M21 before adapting the parameters P1, for example by reducing at least some learning rates.

By executing the first network EQL after its adaptation E150, the first device can equalize the evolved channel CN and estimate signals x(t) which have been emitted by the terminal UE. According to one example, if the alteration of the signal x(t) by the channel CN results in a decrease of its power by half, the neural network EQL implements a function of equalization of the received signal y(t) by multiplying its power by two to estimate the signal x(t). The neural network EQL can compensate for other more complex effects and implement the equalization function with better reliability.

In one embodiment, the parameters P2(t) of the second network FRZ are adapted after a given number of adaptations E150 of the parameters P1(t) of the first network EQL.

In one particular embodiment, during steps E030 and E060, the first network EQL also sends to the second network FRZ (as shown in FIG. 3) the input signals y(t) and the output signals x1(t) estimated by the first network EQL already trained (E020) and adapted (E050). Particularly, the first network EQL can send during the steps E030 and E060 the pilot sequences seq1 and seq2. The learning (E070) of the second neural network FRZ can take into account this complementary information. This information allows the second network FRZ to perceive the operations performed by the first network EQL to estimate a signal x1(t) from a signal y(t). According to this embodiment, the first network also sends the input signals y(t) and the output signals x1(t) during step E100, so that the second network FRZ uses them during the step E110 in the inference phase.

In one particular embodiment, the base station BS sends during steps E030 and E060 only the signals y(t) associated with the learning sequence seq1 and/or seq2 it has received to the server DC. In this particular embodiment, the server DC has information relating to the learning sequence seq1 and/or seq2, for example a learning sequence number, or stores the learning sequence.

In the method described with reference to FIG. 3, the learning E020, E050 of the network EQL and the learning E070 of the network FRZ are of the “supervised learning” type, implemented by considering for the first network EQL sequences of known symbols seq1, seq2 assigned by the channel CN, and for the second network FRZ the information Hi, Hi+1 on the evolution of the channel and the parameters P1(t) before and after the evolution. In another embodiment, the learning of the network EQL and the learning of the network FRZ is of the “unsupervised learning” or “reinforcement” type.

A reinforcement learning of the first or second network is based on an outer function that provides an estimation of the quality of the output provided by the neural network in question. The output provided by the network EQL is the output signal x1(t). The output provided by the network FRZ is a list (for example of the bitmap type) identifying the parameters P1(t) to be adapted and the parameters P1(t) to be frozen.

In one particular embodiment where the learning of the second neural network FRZ is by reinforcement:
the first neural network EQL sends during steps E030 and E060 to the second network characteristics Hi, Hi+1 of the channel before and after its evolution of the channel without sending it the parameters P1(t), the first network EQL being already trained for the characteristics Hi of the channel before the evolution;
the second neural network FRZ randomly determines parameters P1(t) of the first network to be adapted and parameters P1(t) of the first network to be frozen, and provides to the first network EQL information M21 identifying these parameters;
the first network adapts its parameters by applying the information M21 it has received, executes its processing function during an inference phase, and then sends to the second network FRZ information relating to the quality of the processing function after this adaptation. Pilot sequences are used for this learning of the second network;
the second network evaluates the influence of the adapted parameters and of the frozen parameters on the processing function, possibly adjusts the identification of the parameters to be adapted and of the parameters to be frozen, and sends new information M21 identifying these parameters to the first network. Similar exchanges between the first and the second neural network are repeated until the second neural network is optimized.

For the learning of the second network FRZ, a function can be considered which determines a quality of the processing function (the equalization of the channel) performed by the network EQL following a training taking into account the information M21 provided by the network FRZ. This quality can be evaluated in different ways, for example:
a comparison between signals x(t) emitted by the terminal UE and signals x1(t) estimated by the network EQL;
a comparison of the estimated signals x1(t) with signals obtained by a theoretical processing of the emitted signals x(t); or
a comparison of the signals estimated x1(t) by the network EQL trained according to a reinforcement learning with signals estimated x1(t) by the network EQL trained according to a supervised learning.

In the case of a supervised learning, the second network can determine the initialization values of the parameters P1(t) to be adapted, given that this second network is trained (E070) with initial values of these parameters, which have been optimized (E020, E050) by the first network EQL. In the case of a reinforcement learning, the second network can determine the initialization values of the parameters P1(t) to be adapted by being based on an outer function, as it is the case for the determination of the parameters to be adapted and of the parameters to be frozen.

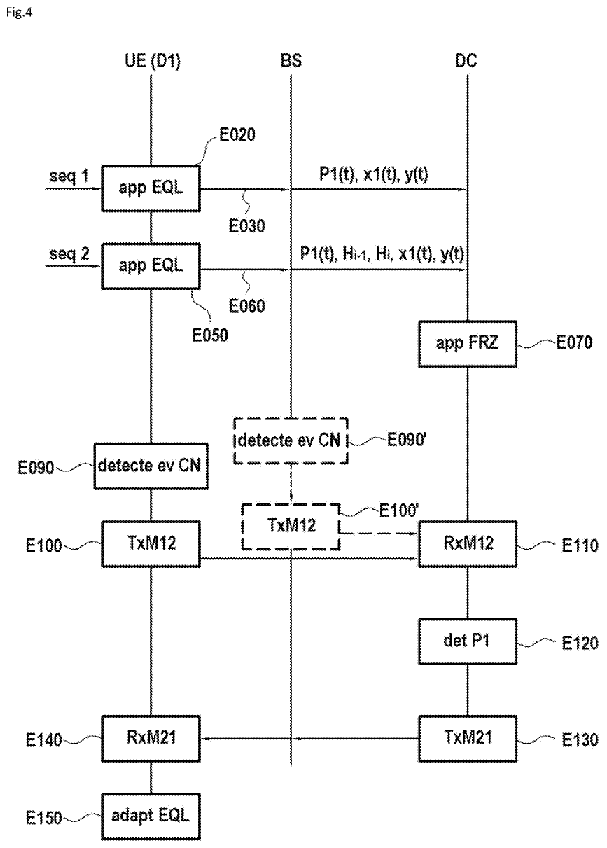

FIG. 4 is a flowchart representing steps of an adaptation method and steps of a determination method, implemented according to a second particular embodiment, respectively by the terminal UE and the server DC described with reference to FIG. 2.

In this embodiment, the terminal UE constitutes a first device in accordance with the invention. The terminal UE is configured to train, adapt and execute the first neural network EQL. The terminal UE uses the network EQL to process signals x(t) emitted by the base station BS. The signals x(t) are altered by the channel CN. This alteration produces signals y(t) received by the terminal UE.

During steps E020 and E050 of the adaptation method, similar to steps E020 and E050 described with reference to FIG. 3, the terminal UE trains the first neural network EQL.

During steps E030 and E060 of the adaptation method similar to steps E030 and E060 described with reference to FIG. 3, the terminal UE sends the estimated signals x1(t), the received signals y(t), and the parameters P1(t) of the first neural network EQL, before and after the first evolution of the channel CN, to the server DC for a processing by the second neural network FRZ. During step E060, the terminal UE also sends the values H(i−1) and Hi of the characteristics of the channel CN before and after the first evolution of the channel.

During a step E070 of the determination method according to the invention, similar to step E070 described with reference to FIG. 3, the server DC trains the second network FRZ in association with the first network EQL based on the information sent (E030, E060) by the terminal UE.

During a step E090 of the adaptation method according to the invention, similar to step E090 described with reference to FIG. 3, the terminal UE detects a second evolution of the channel CN.

During a step E100 similar to step E100 described with reference to FIG. 3, the terminal UE sends the information M12 on the evolution detected to the server DC, via the base station BS. As the use of the radio interface involves resources which are inherently limited, it is preferable that a small amount of information M12 is emitted. In this example, the terminal UE simply transmits the difference between the new estimated values H(i+1) of the characteristics of the channel CN and the previous values Hi of these characteristics for which the network EQL is currently optimized.

In one variant of this second embodiment, the communication channel CN between the terminal UE and the base station BS is reciprocal, for example a TDD (Time Division Duplexing) channel. The base station BS can detect, during a step E090′, the evolution of the channel CN and determine whether the network EQL of the terminal UE requires a new training. If this is the case, the base station sends during a step E100′ information M12 concerning the evolution of the channel, intended for the second network FRZ of the server DC.

During steps E110, E120 and E130 of the determination method according to the invention, similar to steps E110, E120 and E130 described with reference to FIG. 3, the server DC receives the information M12, determines the parameters P1(t) to be frozen and the parameters P1(t) to be adapted and sends the information M21 to the terminal UE, via the base station BS.

During steps E140 and E150 of the adaptation method according to the invention, similar to steps E140 and E150 described with reference to FIG. 3, the terminal UE receives the information M21 and adapts its parameters P1(t) based on the information M21.

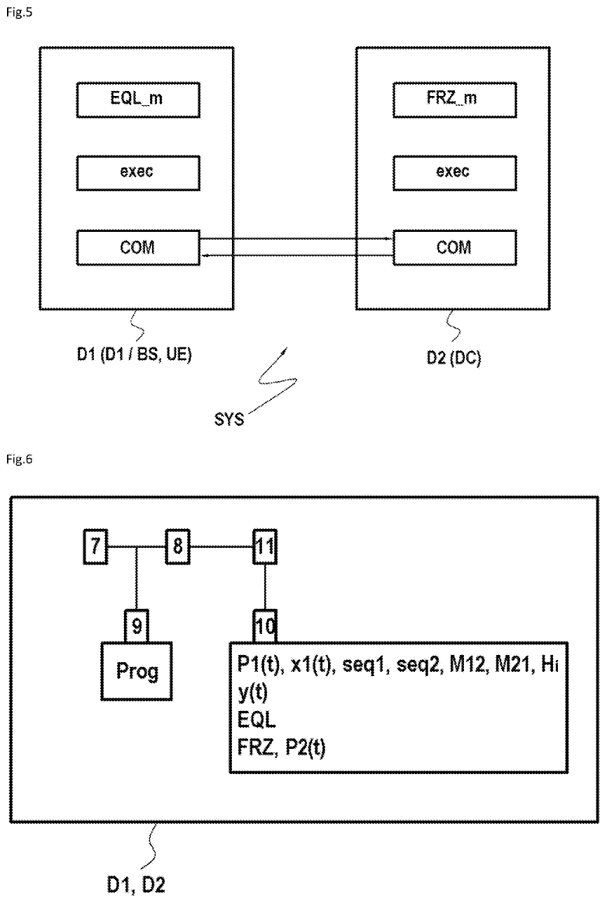

FIG. 5 represents a functional architecture, according to one embodiment of the invention, of a proposed adaptation system SYS.

The system SYS includes:
at least a first device D1 in accordance with the invention, such as the device D1 described with reference to FIGS. 2 and 3 and comprised in the base station BS, or the terminal UE described with reference to FIG. 4; and
a second device D2 in accordance with the invention, such as the server DC described with reference to FIGS. 2, 3 and 4.

These devices D1 and D2 respectively include modules EQL_m and FRZ_m which are configured to train (E020, E050, E070) the neural networks EQL and FRZ, and adapt (E150) their parameters.

Each of the devices D1 and D2 of the system SYS includes an exec module configured to execute the corresponding neural network, EQL or FRZ.

Each of the devices D1 and D2 of the system SYS includes a communication module COM configured to exchange (E030, E060, E100, E110, E130 and E140) the information relating to the evolution of the channel CN, that is to say the information M12, and the information relating to the parameters P1(t) to be adapted and to the parameters P1(t) to be frozen, that is to say the information M21, as explained previously with reference to FIGS. 3 and 4.

In one embodiment, the first device D1 and the second device D2 form a single device, which can for example be included in the base station BS.

In the embodiment described here, each device D1 and D2 of the adaptation system SYS has the hardware architecture of a computer, as illustrated in FIG. 6.

The architecture of each of the devices D1 and D2 in particular comprises a processor 7, a random access memory 8, a read only memory 9, a non-volatile flash memory 10 in one particular embodiment, as well as communication means 11. Such means are known per se and are not described in more detail here.

The read only memory 9 of the device D1 or D2 constitutes a recording medium in accordance with the invention, readable by the processor 7 and on which a computer program Prog in accordance with the invention is recorded here.

The memory 10 of the device D1 or D2 makes it possible to record variables used for the execution of the steps of the method for adapting the parameters of a neural network, as described above, or of the steps of the method for determining the parameters to be frozen or adapted, as described previously. These variables comprise for example the parameters P1(t), the estimated signals x1(t), the received signals y(t), the sequences seq1 and seq2, the values Hi and the information M12 and M21. The memory 10 of the first device D1 further records the first network EQL. The memory 10 of the second device D2 further records the second network FRZ and the parameters P2(t) of this second network FRZ.

The computer program Prog defines functional and software modules, configured here to adapt the parameters of a neural network (EQL) or to determine the parameters to be frozen or adapted. These functional modules are based on and/or control the aforementioned hardware elements 7-11 of the device D1 or D2.

1. A method for adapting parameters of a first neural network used in a communication network to implement a processing by an equipment of an input signal received after transmission by a communication channel of a signal emitted by a terminal and to obtain an output signal, the parameters of the first neural network depending on propagation characteristics of the communication channel, said first neural network has been trained for initial values of propagation characteristics of the communication channel, said method comprising:
following a detection of a deterioration in the quality of the processing due to an evolution of said channel, sending by the first neural network information on said evolution to the second neural network, said second neural network having been trained to establish a match between an evolution of the channel and the adaptation of the parameters of the first network and being used to determine parameters of said first network to be frozen and parameters of said first network to be adapted following an evolution of the channel;
receiving information, provided by said second neural network, that identifies parameters of said first network to be frozen and parameters of the first network to be adapted following the detected evolution; and
adapting the identified parameters of said first neural network by using the information on said evolution provided by said second neural network.

2. The method of claim 1, further comprising sending, in association with the information on said evolution, at least one parameter of said first neural network among a weight and a bias, and/or a value of a loss function and/or at least one component of a gradient of the loss function.

3. The method of claim 1, wherein the information on said evolution includes:
values of propagation characteristics of the channel before the evolution, for which said first neural network is optimized; and
estimated values of these propagation characteristics following the evolution.

4. The method of claim 1, wherein the information on said evolution includes a complex difference between values of characteristics of propagation on said channel before the evolution and estimated values of these characteristics after the evolution.

5. The method of claims of claim 1, wherein the detection of a degradation in the quality of the processing due to an evolution of the channel includes:
a comparison between a threshold and a value of a variation of a characteristic of propagation of the received input signal; and/or
a comparison, for a given input signal, between an output signal obtained by the processing and a reference signal.

6. The method of claim 1, further comprising, before said adaptation, a modification of the information provided by said second neural network and used for said adaptation.

7. A method for determining parameters of a first neural network to be frozen or adapted, said first neural network being used in a communication network to implement a processing by an equipment of an input signal received after transmission by a communication channel of a signal emitted by a terminal and to obtain an output signal, the parameters of the first neural network depending on propagation characteristics of the communication channel, said first neural network having been trained for initial values of propagation characteristics of the communication channel, said method comprising:
learning a second neural network to establish a match between an evolution of the channel and the adaptation of the parameters of the first network;
receiving by the second neural network information on an evolution of said channel resulting in a degradation in the quality of the processing;
determining by said second neural network, from the received information, the parameters of said first network to be frozen and the parameters of said first network to be adapted following said evolution; and
sending to the first neural network information that identifies the parameters to be frozen and the parameters to be adapted.

8. The method of claim 7, wherein said information identifying the parameters to be frozen and the parameters to be adapted includes at least a rate of learning of a parameter of said first neural network and/or at least one weight value associated with a said learning rate.

9. The method of claim 7, further comprising providing to the first neural network initial values of the parameters of the first network to be adapted.

10. The method of claim 1, wherein said second neural network is trained by:
values of the characteristics of said channel before and after an evolution; and
parameters of said first neural network before and after the evolution and/or output signals of the processing associated with said values of the characteristics of the channel.

11. The method of claim 1, wherein said second neural network is trained by:
values of the characteristics of said channel before and after an evolution, the first neural network being trained for the characteristics of the channel before the evolution;
sending to the first neural network of information that identifies the parameters, randomly determined, to be frozen and adapted;
receipt of information on the quality of the processing of the first neural network after adaptation of its parameters according to the provided information;
evaluation of influence of the information provided to determine new information to be provided.

12. The method of claim 10, wherein the second neural network receives, in association with the information on the evolution of the channel, at least one parameter of the first neural network among a weight and a bias, and/or a value of a loss function and/or at least one component of a gradient of the loss function.

13. The method of claim 12, wherein the second neural network uses a gradient back-propagation technique for its learning.

14. The method of claim 1, wherein the first neural network is trained by exploitation of received signals corresponding to a learning sequence emitted by a terminal, a first update of the parameters of the first neural network being performed during this training.

15. The method of claim 14, wherein the parameters of the first neural network are updated iteratively by back-propagation of a gradient by minimizing a cost function based on a quality of the reconstruction at the end of the processing by the first neural network of the learning sequence.

16. The method of claim 1, wherein the processing is a function taken from among:
an equalization function, and
a signal processing function performing at least one time or frequency drift to maintain a time and/or frequency synchronization between an emitter and a receiver.

17. A non-transitory computer readable medium having stored thereon instructions which, when executed by a processor, cause the processor to implement the method of claim 1.

18. A non-transitory computer-readable medium having stored thereon instructions which, when executed by a processor, cause the processor to implement the method of claim 7.

19. A device configured to:
adapt parameters of a first neural network used in a communication network to implement a processing by an equipment of an input signal received after transmission by a communication channel of a signal emitted by a terminal and to obtain an output signal, the parameters of the first neural network depending on propagation characteristics of the communication channel, said first neural network has been trained for initial values of propagation characteristics of the communication channel, according to a method comprising:
following a detection of a deterioration in the quality of the processing due to an evolution of said channel, sending by the first neural network information on said evolution to the second neural network, said second neural network having been trained to establish a match between an evolution of the channel and the adaptation of the parameters of the first network and being used to determine parameters of said first network to be frozen and parameters of said first network to be adapted following an evolution of the channel;
receiving information, provided by said second neural network, that identifies parameters of said first network to be frozen and parameters of the first network to be adapted following the detected evolution; and
adapting the identified parameters of said first neural network by using the information on said evolution provided by said second neural network.

20. A system for adapting the parameters of a first neural network, said system including:
at least one device configured to adapt parameters of a first neural network used in a communication network to implement a processing by an equipment of an input signal received after transmission by a communication channel of a signal emitted by a terminal and to obtain an output signal, the parameters of the first neural network depending on propagation characteristics of the communication channel, said first neural network has been trained for initial values of propagation characteristics of the communication channel, according to a method comprising:
following a detection of a deterioration in the quality of the processing due to an evolution of said channel, sending by the first neural network information on said evolution to the second neural network, said second neural network having been trained to establish a match between an evolution of the channel and the adaptation of the parameters of the first network and being used to determine parameters of said first network to be frozen and parameters of said first network to be adapted following an evolution of the channel;
receiving information, provided by said second neural network, that identifies parameters of said first network to be frozen and parameters of the first network to be adapted following the detected evolution; and
adapting the identified parameters of said first neural network by using the information on said evolution provided by said second neural network; and
a second device according to claim 22, the second device having a higher computing capacity than that of said at least one first device.

21. The system of claim 20, wherein said at least one first device is a base station or a terminal and said second device is a server of a core of said communication network.

22. A device configured to determine parameters of a first neural network to be frozen or adapted, said first neural network being used in a communication network to implement a processing by an equipment of an input signal received after transmission by a communication channel of a signal emitted by a terminal and to obtain an output signal, the parameters of the first neural network depending on propagation characteristics of the communication channel, said first neural network having been trained for initial values of propagation characteristics of the communication channel, according to a method comprising:
learning a second neural network to establish a match between an evolution of the channel and the adaptation of the parameters of the first network;
receiving by the second neural network information on an evolution of said channel resulting in a degradation in the quality of the processing;
determining by said second neural network, from the received information, the parameters of said first network to be frozen and the parameters of said first network to be adapted following said evolution; and
sending to the first neural network information that identifies the parameters to be frozen and the parameters to be adapted.
